(19) United States
(12) Patent Application Publication
(10) Pub. No.: US 2006/0165957 A1
(43) Pub. Date: Jul. 27, 2006

(54) Method for producing at least one small opening in a layer on a substrate and components produced according ot said method

(76) Inventors: Egbert Oesterschulze, Kaiserslantern (DE); Rainer Kassing, Kassel (DE); Georgi Georgiev, Kaiserslantern (DE)

Correspondence Address: Striker Striker & Stenby, 103 East Neck Road, Huntington, NY, 11743, US

(21) Appl. No.: 10/523,468

(22) PCT Filed: Aug. 4, 2003
(86) PCT No.: PCT/DE03/02626

§ 371 Date: Sep. 2, 2005

(30) Foreign Application Priority Data
Aug. 5, 2002 (DE) 102 36 150.9

(51) Int. Cl. B32B 3/10

(52) U.S. Cl. 428/131; 428/156

(57) ABSTRACT

A method is described for producing at least one small opening (10) in a layer on a substrate (1), in particular a semiconductor substrate. The substrate (1) is provided on the upper side (2) with at least one tapering recess (6), which has a tip portion (4) and side walls (5), and the upper side (2) of the substrate (1) is covered at least in the region of the recess (6) with a layer (7) made of an etchable material. According to the invention, the opening (10) is produced from the upper side (2) by selective opening of the layer (7) by means of an anisotropic plasma etching method which is matched to the material of the layer (7), the material, the etching gases and the etching parameters being chosen such that in the region of a tip portion (9) of the layer (7), which tip portion (9) lies on the tip portion (4) of the substrate (1), a greater etching rate is produced than in the region of side walls (8) of the layer (7) which lie on the side walls (5) of the substrate (1). In addition, calibration standards, bending beams and other component parts, which are produced according to this method, are described (FIG. 1).

Method for producing at least one small opening in a layer on a substrate and component parts produced therewith The invention relates to a method for producing at least one small opening in a layer on a substrate, in particular a semiconductor substrate, the substrate being provided on the upper side with at least one tapering recess, which has a tip portion and side walls, the upper side of the substrate being covered at least in the region of the recess with a layer made of an etchable material and the opening being then produced in the region of the tip portion by etching of the layer.

The openings of interest within the scope of the present invention concern in particular punctiform or linear openings (apertures) which have diameters or widths in the nanometre range. Openings of this type are required for example as components of probes for “scanning near-field optical microscopy”=SNOM or “near-field scanning optical microscopy”=NSOM. As in all scanning near-field techniques, the achievable resolution is hereby limited by the geometry and the dimensions of the probe, in particular of the probe opening, and the spacing of the probe from the surface. In order to achieve sub-wave resolutions, it is necessary that the emitting or light-detecting region of the probe has lateral dimensions significantly below 1 ìm, preferably below 100 nm.

In addition, openings with dimensions of this type can also be applied advantageously for example in particle filters, sieves, permeable membranes, optical space filters, ultra-small contactings and layered components and also numerous further devices, e.g. in etching masks intended for the production of semiconductor component parts.

Finally, in the field of scanning probe microscopy, there is in general a requirement for three-dimensional calibration standards and sensors in the form of bending beams (cantilevers), which are fixed on one side and have openings in the nanometre range for near-field optical devices.

It is known (DE 199 26 601 A1) for producing small openings to provide the upper side of a substrate with recesses in the form of tapering channels or inverse pyramids standing on the tip and to etch the substrate from its underside until the tips are reached and small openings are produced in the region of the tips. A substantial disadvantage of this method resides in the fact that the thickness of normal substrates varies greatly and consequently can already have thickness variations of approx. 10 ìm such that, despite application of defined etching parameters, openings with different diameters or widths are produced and/or the tips of the recesses are not opened at all. This method is therefore not suitable for reproducible production of openings with precisely preselected dimensions.

Another known method (likewise DE 199 26 601 A1) begins with a silicon substrate which is provided on its upper side with tapering recesses and a thermally applied silicon dioxide layer. In order to produce the openings, the fact is exploited that the silicon dioxide layer has inhomogeneities in the region of the tips of the recesses, which can be exposed by selective etching of the substrate from the rear side, and can then be opened selectively by a further etching step. One thereby produced disadvantage resides in the fact that the exposed tips, which have the openings, protrude beyond the underside of the substrate and hence are not suitable for application cases which essentially require plane-parallel substrates. In addition, only opening widths or opening diameters of approx. 150 nm to 200 nm and more have been achievable to date with this method and have been applicable only with specific material systems, such as e.g. silicon substrates which have thermally produced silicon dioxide layers.

In contrast, the technical problem underlying the invention is to produce a method of the initially described type with which small openings with diameters or widths of approx. 100 nm or less can be produced reproducibly even in plane-parallel substrates and which can be applied in addition in different material systems.

In order to achieve this object, the method of the initially described type is characterised according to the invention in that the opening is produced from the upper side by selective opening of the layer by means of an anisotropic plasma etching method which is matched to the material of the layer, the material, the etching gases and the etching parameters being chosen such that, in the region of the tip portion of the recess, a greater etching rate is produced than on the side walls of the recess.

According to the invention, a calibration standard for scanning probe microscopy and a bending beam are proposed in addition, which are both provided with openings produced according to the method according to the invention. The bending beam is suitable above all for producing a micromechanical sensor.

The invention is based on the knowledge that, in numerous coatings for substrates of the type of interest here, a distinctive etching rate angle distribution is produced when the layers are subjected to a plasma etching process from the upper side. This etching rate angle distribution can in addition be not only a consequence of the selected coating but also be configured locally, in that layers which passivate for example during the etching process are deposited less thickly on surfaces which are perpendicular to the plasma than on surfaces which are diagonal thereto. The layer thicknesses of these deposits can thereby depend upon the orientation of the surfaces. In addition, the electrical potential distribution during the plasma etching process can have an effect such that, in the region of the tip portion, a different etching rate is obtained than in the region of the side walls. All these and other effects and causes of different etching rates are combined within the scope of the present invention under the description “etching rate angle distribution”. The invention therefore provides that the upper side of a structured substrate is covered with a layer of a suitable composition, morphology and thickness and then is subjected to a plasma etching method with suitable etching gases and parameters (in particular pressure, temperature etc.), which method, utilising the respective etching rate angle distribution in the region of the side walls, leads to significantly lower etching rates than in the region of the tip portions of the recesses. As a consequence, openings with diameters or widths of approx. 90 nm have been able to be obtained to date.

Further advantageous features of the invention are revealed in the sub-claims.

The invention is explained subsequently in more detail in embodiments in conjunction with the accompanying drawings. There are shown:

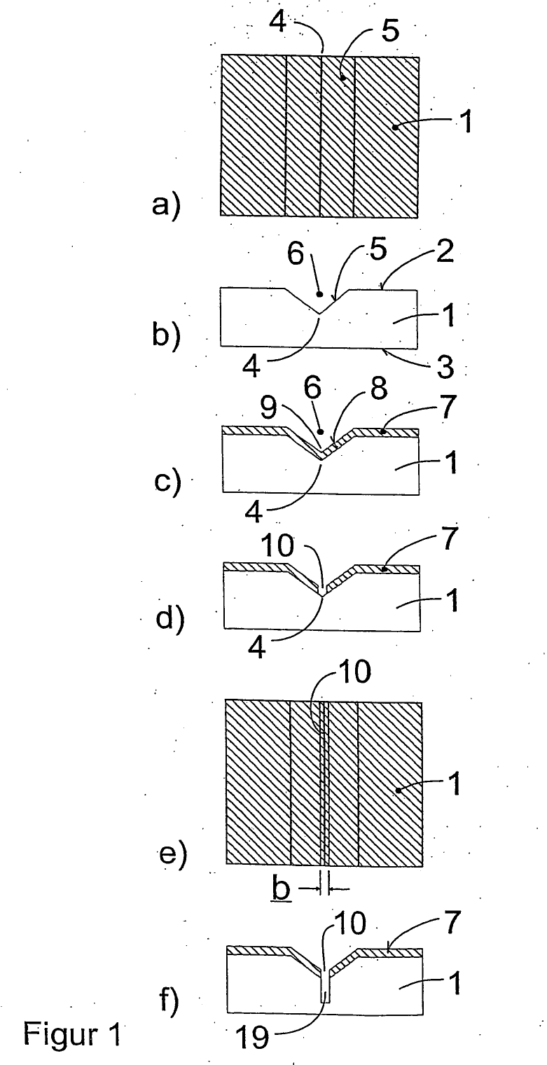

FIG. 1a to 1f schematically, different method steps during application of a first embodiment of the method according to the invention with reference to plan views on a substrate (FIGS. 1a, 1e) and cross-sections through the substrate (FIG. 1b to 1d and 1f);

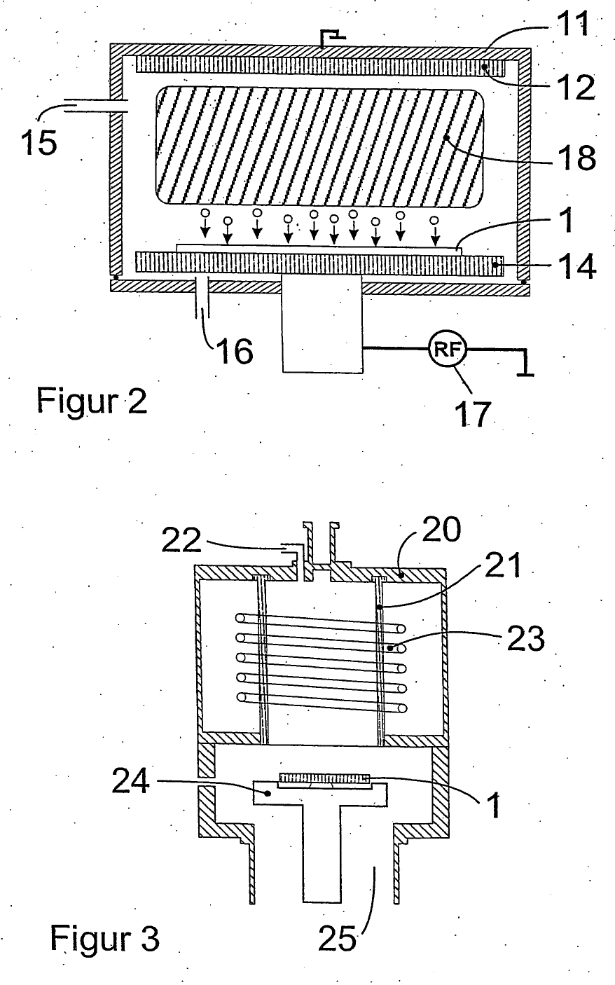

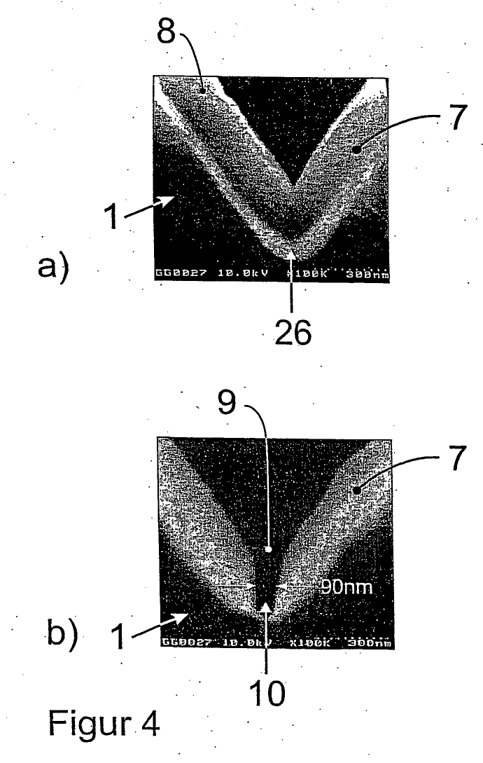

FIGS. 2 and 3 schematic vertical sections through devices for implementing etching steps, applying the method according to FIG. 1;

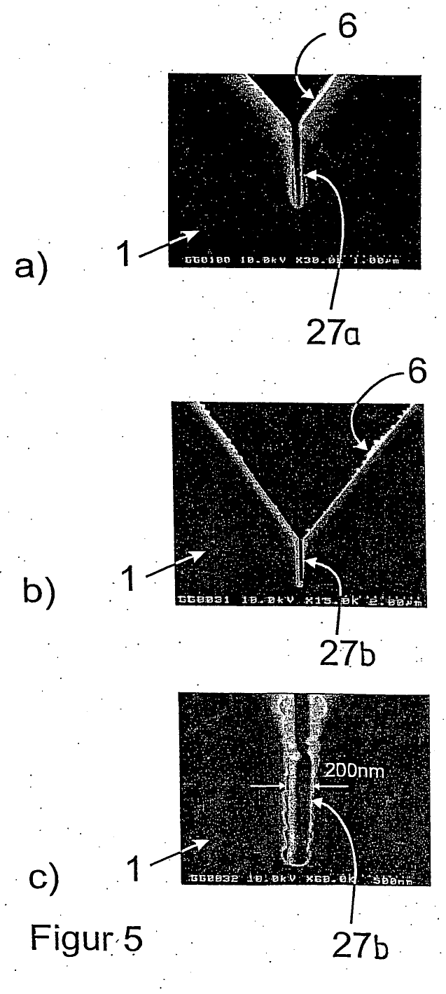

FIGS. 4a and 4b respectively an image of a substrate cross-section, produced with a scanning electron microscope, before and after production of an opening in a layer applied on the substrate, applying the method according to FIG. 1;

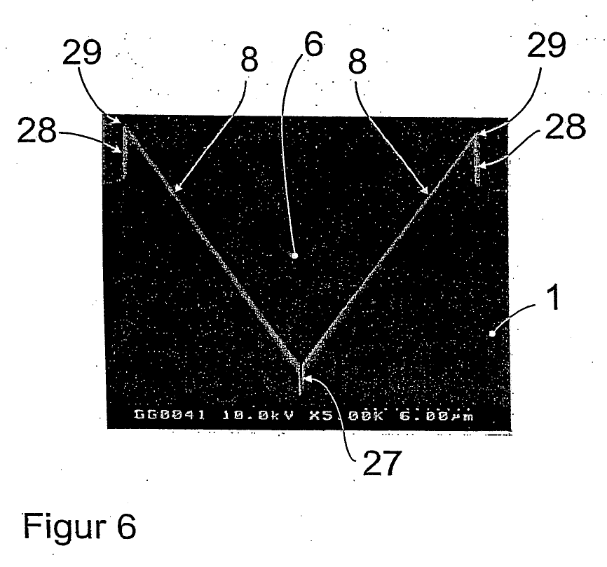

FIG. 5a to 5c images corresponding to FIGS. 4a and 4b but after deep etching of the substrate, using the layer containing the openings as etching mask, on different scales;

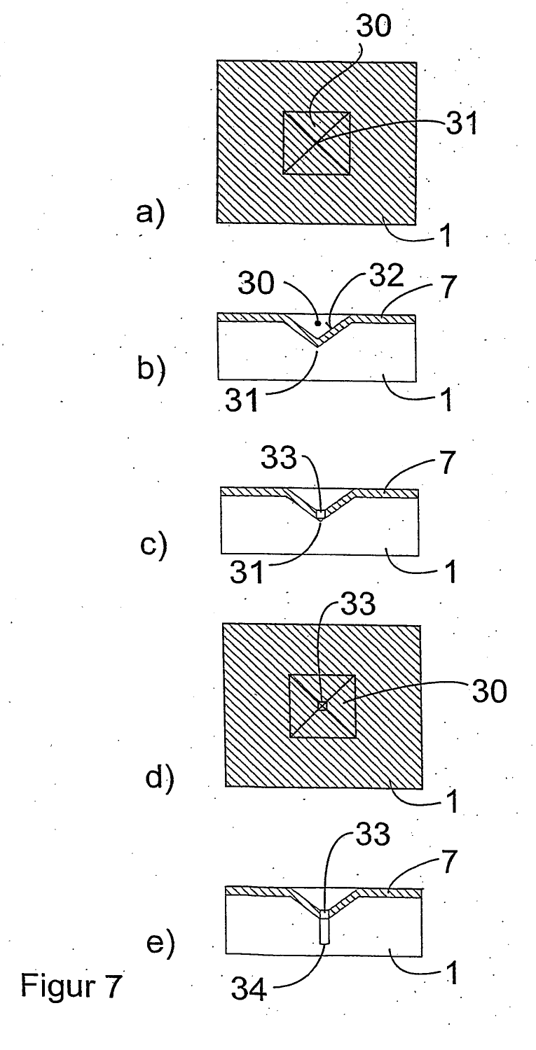

FIG. 6 an image obtained with a scanning electron microscope analogously to FIGS. 4 and 5 but with an additional etching edge obtained during deep etching;

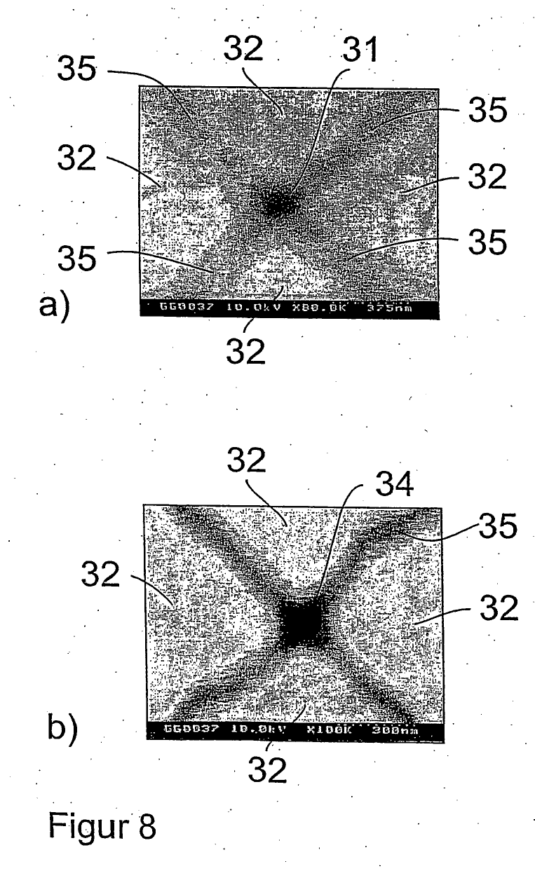

FIG. 7a to 7e views corresponding to FIG. 1a to 1f, applying a second embodiment of the method according to the invention;

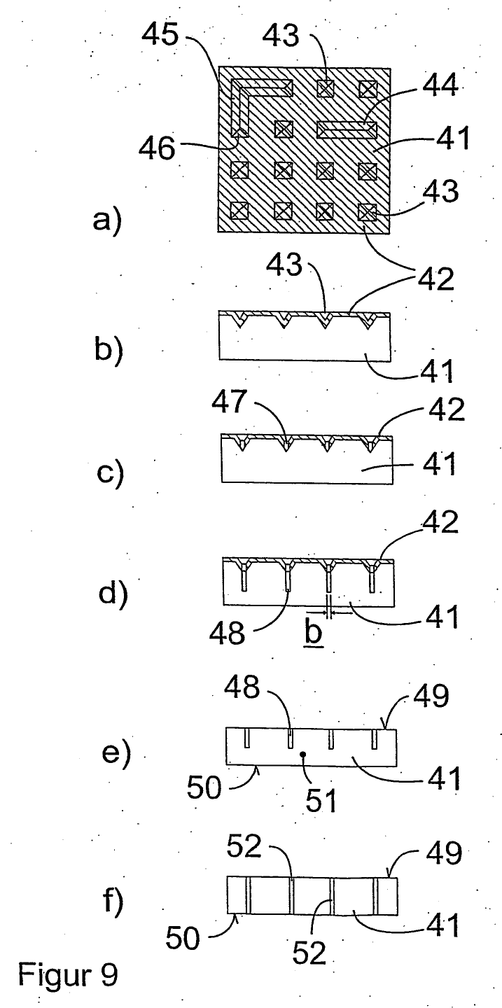

FIGS. 8a and 8b plan views obtained with a scanning electron microscope on a structured substrate, provided with an etchable layer, before and after configuration of an opening;

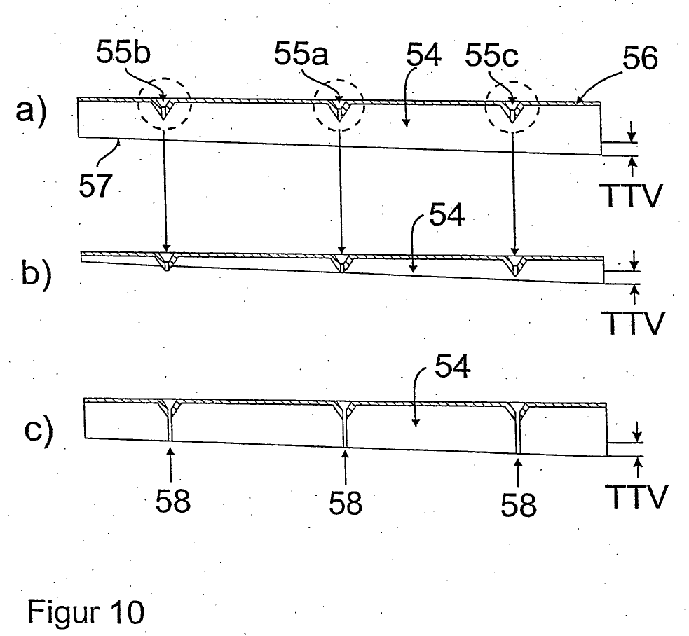

FIG. 9a to 9f views corresponding to FIG. 1a to 1f, applying a third embodiment of the method according to the invention;

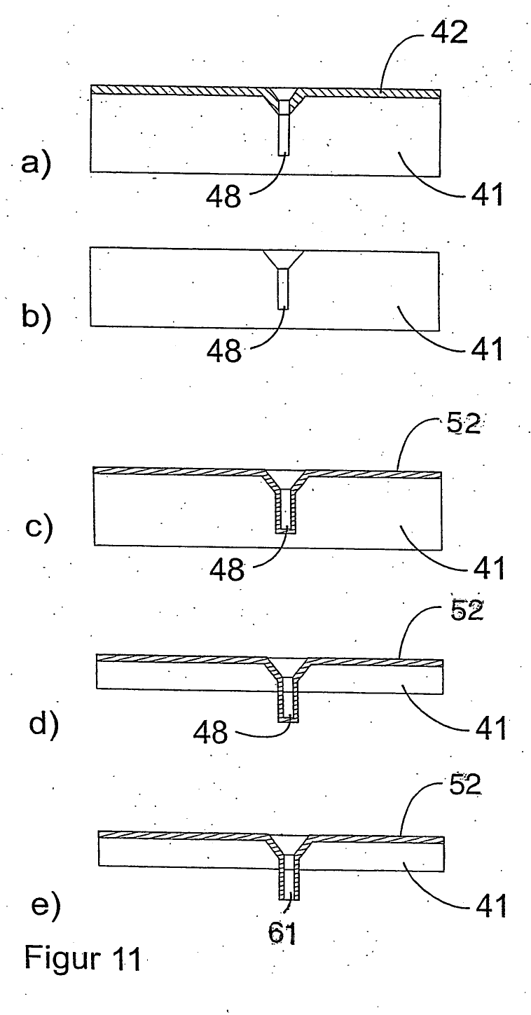

FIG. 10a to in schematic cross-sections of a substrate, a comparison

10c between a known method and the one according to the invention; and

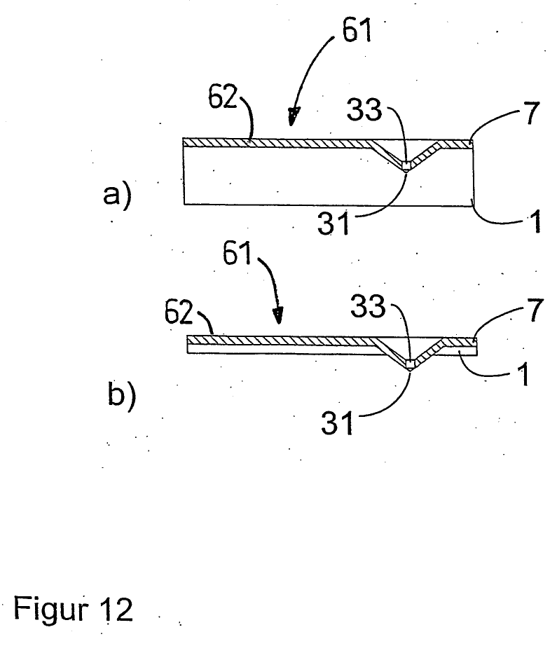

FIG. 11a to in views corresponding to FIG. 1a to 1f, two further to 11e and embodiments of the method according to the invention.

FIGS. 12a, 12b

A first embodiment of the method according to the invention is illustrated schematically in FIG. 1a to 1f. In a first method step (FIGS. 1a and 1b), a substrate 1 is structured. The substrate 1 is present here as a thin, essentially plane-parallel, monocrystalline silicon disc which has an upper side 2 orientated as (001) crystal face and an underside 3. The structuring produced on the upper side 2 in the first method step contains at least one tapering recess 6 which has a tip portion 4 (apex) and two side walls. The recess 6 is produced in that the upper side 2 is provided firstly with a mask in a manner known per se, said mask having a rectangular opening, and then is etched anisotropically through this mask opening for example with an aqueous potassium hydroxide solution (KOH). During this etching process, the side walls 5 obtain a (111) orientation, and a recess 6 in the form of a straight, V-shaped channel is produced with an opening angle between the side walls 5 of approx. 70.5 _{E}. According to FIGS. 1a and 1b, the recess 6 extends over the entire length, preferably however only over a part of the width of the substrate 1. The non-illustrated masking layer comprises for example a previously applied silicon dioxide (SiO₂) or silicon nitride (SiNₓ) layer.

In a second method step, the substrate 1 is covered on its entire structured upper side 2 with a layer 7 of silicon dioxide of for example approx. 30 nm thickness (FIG. 1c) in that the substrate 1 is thermally oxidised at temperatures of e.g. 800 _{E}C to 1200 _{E}C with water vapour as oxidation means or is coated, by a CVD method (=chemical vapour deposition), e.g. using dinitrogen oxide (N₂O) and silane (SiH₄), with SiO₂. The SiO₂ layer 7 can thereby be provided by using oxidation temperatures between approx. 800 _{E}C and 900 _{E}C, if required with characteristic inhomogeneities in the region of the convex or concave edges of the channel structure (e.g. DE 199 26 601 A1). The shape of the recess 6 according to FIGS. 1a and 1b is essentially maintained during the described coating process so that corresponding side walls 8, which are disposed in a V-shape, and a tip portion 9 are produced on the upper side of the layer 7. The masking layer used in the preceding method step can be removed before application of the SiO₂ layer 7, but can also be left.

The substrate 1 is now treated from its upper side 2 with a suitable plasma etching method in order to provide the layer 7 in the region of the tip portion 9 with a through-opening 10 (FIGS. 1d and 1e). The plasma etching process is implemented by means of a capacitively coupled parallel plate reactor, which is known per se and illustrated schematically in FIG. 2, said reactor having a housing 11 with an upper electrode 12 and a lower electrode 14 on which the substrate 1 is placed. In addition, a gas inlet 15, a gas outlet 16 and a high frequency generator 17 connected to the lower electrode 14 are present, said generator being operated here at 13.56 MHz with a power of approx. 160 W.

Argon (Ar) is supplied at 5 sccm and trifluoromethane (CHF₃) at 4.5 sccm to the gas inlet 15. A pressure of approx. 75 mTorr is maintained in the housing 11 via the gas outlet. The plasma 18, which is produced during operation of the device according to FIG. 2, leads to a direct bias voltage of the substrate 1 of 250 V.

In the embodiment, the etching duration is 7 min with a thickness of the SiO₂ layer 7 of 300 nm. As a result, there is produced in the region of the tip portion 9 of the layer 7 (FIG. 1c) a slot-like opening 10 (FIGS. 1d and 1e), which penetrates to the tip portion 4 of the substrate 1 and has a width b (FIG. 1e) of approx. 90 nm which remains essentially constant over the entire length of the recess 6. This is a consequence of the fact that the mentioned etching gasses and etching parameters are matched to each other such that, within the SiO₂ layer 7, a distinctive etching rate angle distribution is obtained relative to the chosen plasma etching process which is recognised as suitable for this case, and the SiO₂ layer 7 in the region of its tip portion 9 is etched at a greater etching rate than in the region of its side walls 8.

Subsequent to the production of the opening 10, the SiO₂ layer 7 provided with said opening is used as etching mask in a subsequent deep etching step which serves the purpose of continuing and lengthening the opening 10 configured in the SiO₂ layer 7 through the substrate 1. As a result, in this method step (FIGS. 1e, 1f), a groove-like gap or channel 19, which is open towards the opening 10 and has essentially the same width as the opening 10, is obtained in the substrate 1.

Deep etching is implemented for example with an inductively coupled plasma etching device which is suitable for deep etching of silicon and is illustrated schematically in FIG. 3. Said device contains a housing 20 with a vertically disposed quartz pipe 21 which is closed at its upper end but has a gas inlet 22. A water-cooled HF winding 23 is wound around the quartz pipe 21 in addition. The lower, open end of the quartz pipe 21 is directed towards an electrode 24, on which the substrate 1 to be treated is situated. The space enclosed by the quartz pipe 21 and surrounding the substrate 1 are connected via a gas outlet 25 to a high-power pump. A cooling device, not shown in more detail, is assigned in addition to the electrode 24 in order to keep the substrate 1 at a temperature of e.g. 10 _{E}C during operation of the device.

In order to implement the etching steps, according to a first embodiment, argon is supplied at approx. 24 sccm, sulphur hexafluoride (SF₆) at approx. 18 sccm and oxygen (O₂) at approx. 30 sccm. A pressure of 10 mTorr is thereby set in the housing 21 via the gas outlet 25. The winding 23 is operated at 600 W with a frequency of 13.56 MHz, a direct bias voltage of 127 V arising or being set by the formed plasma. The substrate temperature is maintained at 10 _{E}C. The etching durations are approx. 2 min.

Alternatively, an extensively anisotropic deep etching can also be obtained by applying a deep etching method which is known per se and in which etching and polymerisation steps which follow each other alternately are implemented. The etching steps serve for section-wise etching of the zones of the substrate 1 which are situated below the opening 10. However, during the polymerisation steps, a polymer is applied on the lateral limits, which are defined by the opening 10, of the structure forming in the substrate 1 in order as a result to avoid extensively sub-etchings such as would be produced during isotropic etching. Also as a result, in the method step (FIGS. 1e, 1f), the groove-like gap or channel 19 in the substrate 1, which is open towards the opening, is obtained, said gap or channel having essentially the same width as the opening 10.

In order to implement the etching steps, applying this method according to a second embodiment, argon is supplied at approx. 17.1 sccm, sulphur hexafluoride (SF₆) at approx. 35 sccm and oxygen (O₂) at approx. 5 sccm. The winding 23 is operated at 550 W with a frequency of 13.56 MHz, a direct bias voltage of 96 V being set by the formed plasma. The etching durations are approx. 18 s. The remaining parameters are as in the first mentioned example.

In order to implement the polymerisation steps, applying the same device according to FIG. 3, CHF₃ is supplied at 40 sccm and methane (CH₄) at 5 sccm. With otherwise identical parameters, a pressure of 60 mTorr is maintained in the housing 20, and the direct bias voltage set during the plasma development is approx. 24 V. The polymerisation steps are implemented with a duration of approx. 8 s respectively.

Deep etchings of this type are known e.g. from the German patent specification DE 42 41 045 C1 which, in order to avoid further explanations, is hereby made the subject of the present disclosure by reference thereto.

The openings 10 or channels 19 obtained with the described method are illustrated in FIGS. 4, 5 and 6 with reference to scanning electron microscope images.

Firstly, the channel structure with its apex, which is obtained by coating with SiO₂, is clearly detectable in FIG. 4a. However, FIG. 4b shows the already configured opening 10 with a width of 90 nm.

On different scales, FIG. 5 shows two groove-like channels 27 which are produced by the deep etching step. The channel 27a, which can be seen in FIG. 5a, has been produced thereby with the method applied in the first embodiment, however the channel 27b, which can be seen in FIGS. 5b and 5c, has been produced with the method applied in the second embodiment. The SiO₂ layer 7 was respectively removed entirely before production of the scanning electron microscope images so that only the recess 6 in the substrate 1 is visible. According to FIG. 5c, even with a considerable channel depth of e.g. 1.5 ìm, a channel width of only approx. 200 nm is obtained.

Finally, it is illustrated in FIG. 6 that steeply sloping steps 28 in the silicon substrate 1 can also be obtained by the deep etching step, said steps transcending into the side walls 5, 8 of the substrate 1 or into the SiO₂ layer 7 along sharp edges 29. This is a consequence of the fact that, when opening the layer 7 at the apex, the layer 7, which is situated on the upper side of the substrate 1, is also removed by etching because of the described etching rate angle distribution since the etching rate here has a similar value to the etching rate at the apex due to the same orientation. In the case of highly anisotropic deep etching with the SiO₂ layer 7 as etching mask, the steps 28 respectively are configured therefore on the sides of the substrate 1. These steps 28 can be used for forming etching troughs in the silicon disc and hence e.g. in semiconductor technology for producing three-dimensional field effect transistors. If steps 28 of this type are intended to be avoided or configured only at preselected places, the upper side of the SiO₂ layer 7 must be covered totally or partially with suitable masks outwith the channel structure and before production of the opening 10, said masks precluding an etching attack on the silicon substrate 1.

The embodiment according to FIGS. 7 and 8 differs from that according to FIG. 1 to 6 only by the different shape of the opening and the thus produced structures in the substrate 1. Analogously to FIG. 1, the substrate 1 is firstly provided on its upper side with a tapering recess and then is covered with an SiO₂ layer 7 which has a corresponding recess 30 with a tip portion 31 and is delimited by side walls 32 (FIG. 7b). Deviating from FIG. 1, the recess 30 has the form of an inverse pyramid which stands on the tip 31 and has a square base, as can be detected in the plan view in FIG. 7a. If the surface of the silicon substrate 1 concerns a (001) crystal face, then all four side walls 32 are orientated after implementation of the first etching step (111). The produced structure is therefore delimited on four sides instead of on only two sides.

In the tip portion 31 of the recess 30, an opening 33 (FIG. 7c) is configured in the same manner as described above with reference to FIG. 1, said opening completely penetrating the layer 7 or its tip portion 31. In the plan view according to FIG. 7d, the cross-section of this opening 33 is essentially square with an edge length of approx. 150 nm. If the SiO₂ layer 7 which has the opening 33 is therefore used analogously to FIG. 1 as etching mask for a finishing deep etching process, then, in the thereunder situated substrate 1, according to FIG. 7e, only one shaft-like hollow 34 with a cross-section corresponding essentially to the cross-section of the opening 33 is produced.

FIG. 8 shows images, produced by a scanning electron microscope, of substrates treated according to FIG. 7. In particular, FIG. 8a shows a plan view on the thermally applied SiO₂ layer 7 with its recess 30 (FIGS. 7a and 7b), the central tip portion 31, the side walls 32 and section lines 35, which are formed by the latter and appear in hatching, are detectable, on which section lines the side walls 32 abut together in pairs. However, FIG. 8b shows an image in which the SiO₂ layer 7 has been treated already by means of the etching step described with reference to FIG. 1, said etching step progressing anisotropically because of the existing etching rate angle distribution and hence leading to the opening 34 in the apex region.

A third embodiment of the invention, which is perceived presently as the best, is illustrated in FIG. 9. Deviating from FIGS. 1 and 7, here a silicon substrate 41 is provided on its (001) upper side with a plurality of recesses, which are disposed for example in a matrix-shape, said recesses being pyramids which stand respectively if necessary on the tip or being tapering channels which, deviating however from FIG. 1, are closed by side walls at their longitudinal ends. The silicon substrate 41 was covered thermally with a thin SiO₂ layer 42 after structuring (FIG. 9b) so that, on the upper side of the substrate 41, recesses 43, 44 and 45, which are covered with SiO₂ and described with reference to FIGS. 1 and 7, are present, said recesses having square or rectangular contours respectively according to the desired structure. The recesses or channels 44, 45, which are provided with rectangular cross-sections, can thereby be disposed with longitudinal axes which are at right angles to each other, as FIG. 9a clearly shows.

The side walls (e.g. 46 in FIG. 9a), which are formed on the longitudinal ends of the recesses 44, 45, are situated respectively according to the case parallel to (111) faces of the substrate 41 or also not.

After configuration of the SiO₂ layer 42, the substrate is subjected from its upper side to a plasma etching step analogously to FIG. 1b so that, in the tip portions of all existing recesses 43, 44 and 45, one opening 47 respectively is produced, all the openings 47 being produced with the same etching step. The SiO₂ layer 42, which is produced in this way and provided with the openings 47, is provided in a subsequent deep etching step with shaft-like hollows or channels 48 (FIG. 9d), the mode of operation described with reference to FIG. 1 to 7 being used analogously and hence analogous results being achieved.

The substrate 41 is provided in a further method step, subsequent to the deep etching step, with planar upper sides and undersides 49, 50 (FIG. 9e) in that, if necessary after prior removal of the SiO₂ layer 42 with KOH, these are polished by plasma etching or similar for example with a chemical-mechanical method. The consequently obtained surfaces are smooth (flat) and provided with essentially identical structures. This method step can be undertaken independently of whether the substrate 41 is provided during deep etching with hollows or groove-like channels 48 which are configured in the manner of blind holes and have closed bases 51 (FIG. 9e) or whether the substrate 41 is provided with column-like passages or slots or gaps 52 which penetrate the substrate 41 completely (FIG. 1f).

A particular advantage of the embodiment according to FIG. 9 resides in the fact that, due to the described etching rate angle distribution, all the openings 47 configured in the same substrate 41 and hollows/channels 48 or passages/slots 52 produced with these have essentially the same widths b (FIG. 9d) which are in the nanometre range and are reproducible with low width variations.

The substrate 41 according to FIG. 9f can be applied outstandingly as the calibration standard since, in contrast to known devices (DE 199 26 601 A1), it can be provided readily with planar, smooth upper sides and undersides. The principle of such a calibration standard is to make available hole-like or linear structures with reproducible geometries and with an optically opaque substrate which is however as small as possible. The planarity of the surface must be demanded in order not to obtain topography-caused artefacts in the near-field optical imaging (APL). The probe of a scanning near-field microscope can therefore be moved along close to the plane faces 49, 50. In addition, if one of the passages or slots 52 should become dirty, blocked or unusable for other reasons, other numerous further passages or slots 52 of the same substrate with identical dimensions are present and hence in a redundant manner. In this way, the practical duration of use of the calibration standard in comparison to known devices is substantially increased.

A further substantial advantage of the invention is produced in FIG. 10. In FIG. 10a, a substrate 54 is illustrated with a typical thickness variation TTV (total thickness variation) of approx. 1 to 10 ìm and with a plurality of openings 55 in a thermally applied SiO₂ layer 56. If attempts were made to expose the openings 56 from the underside 57 of the substrate 54 by etching with KOH or the like (DE 199 26 601 A1), then an end product according to FIG. 10b would be obtained, in which not all the openings 56 have been exposed at the same time. Rather, for example the opening 55a in the centre of FIG. 10b is just exposed, whilst the left-hand opening 55b is in fact exposed but forms an undesired tip contour. The opening 55c situated on the right is still buried in the substrate 54 and hence can be exposed only by means of a substantially longer etching duration in comparison to the opening 55b, as a result of which opening cross-sections of different sizes can be produced. When applying the method according to the invention, an end product according to FIG. 10c with passages or slots 58 is obtained in contrast, said passages or slots having not only essentially identical geometries and sizes but, in addition to the passages or slots 58, also having no further structures. For this reason also, the substrate 41 according to FIG. 9f is particularly well suited as calibration standard. In addition, it is advantageous in this connection that the structures in FIG. 10c do not protrude from the underside of the substrate 54 by different lengths, which would not be acceptable for an application as a calibration standard. When applying the method according to the invention, the opening sizes are in contrast extensively independent of a thickness variation of the substrate and/or of the applied layer 56.

The configuration of the channel or pyramid structure, which is described with reference to FIGS. 1 and 7 and necessary for the method according to the invention, in silicon substrates with (001) surfaces is generally known to the person skilled in the art. In order to avoid repetitions, reference is made in this connection for example to the publications DE 41 26 151 A1, DE 42 02 447 A1, U.S. Pat. No. 5,116,462 A and U.S. Pat. No. 5,399,232 A which are herewith made the subject of the present disclosure by reference thereto.

The invention, which is described with reference to a silicon substrate covered with an SiO₂ layer, can be applied analogously also with other substrates, e.g. those made of germanium, indium phosphide or gallium arsenide, and in a corresponding modification also with other than SiO₂ layers. One difference resides thereby, dependent upon the semiconductor material if necessary in the different opening angles of the channels or inverse pyramids and/or such as for example when using gallium arsenide, in the fact that channels can be produced analogously to FIG. 1b which are delimited only on two sides but no inverse pyramid structures, analogously to FIG. 2b, which are delimited on four sides.

It is clear furthermore that possibly also other structures are possible and other than the described plasma etching methods for producing the openings 10, 33 etc. can be applied. For the purposes of the invention, it is important, on the one hand, that a structured substrate, which could also comprise a layer system containing a plurality of layers, is covered with a layer on at least one broad side and at least in the region of the structures, which layer comprises a suitable material or a material composition, which has i.e. a useable etching rate angle distribution, and is applied in a suitable thickness, the word “layer” also including layer systems which are composed of a plurality of individual layers and/or material compositions. On the other hand, the invention proceeds from the fact that, in order to produce the openings 10, 33, a suitable plasma etching method, in particular a reactive ion etching method is applied, in which chemical and physical etching mechanisms are combined. By prescribing suitable etching gases and suitable plasma etching parameters (pressure, temperature, coupled power, frequency of the generator, direct bias voltage etc.), the respective component can be increased or reduced. This has the result that the achievable etching rate of the masking layer is dependent in particular upon the orientation of the surface structures and can be adapted by varying the above-mentioned plasma etching parameters. It can therefore be achieved by adapting the plasma etching process or by varying the surface structure that the etching rate for the masking layer on the side walls (e.g. 8 in FIG. 1) becomes significantly smaller than that at the apex (e.g. 9 in FIG. 1) since the orientation thereof and hence the associated etching rate is different. Since in addition the apex region is chosen according to the invention to taper, which includes also recesses in the form of a cone or the like which are situated at the tip, the obtained openings (e.g. 10 in FIG. 1) are extremely small and readily reproducible. It is also advantageous that the openings 10, 33, 47 are produced from a large structure (e.g. FIG. 1a, FIG. 7a, FIG. 9b) in a constrained manner, i.e. self-adjusting on the tapering base (line or point) of the respective structure, the production of arcuate openings also being conceivable.

A further important feature of the invention resides in the fact that the openings 10, 33, 47 are produced still in the presence of the substrate 1, 41 and the layer 7, 42 can therefore be used with the already present openings 10, 33, 47 for definition of smaller structures in the substrate 1, 41. As an alternative to the described channels 19, hollows 34 or slots 52, for example a further functional layer could be applied on the uppermost layer in order to produce an extremely small contact to the substrate or to a not yet through-etched layer in the layer system through the opening or the more deeply etched structure.

Furthermore, additional material for reducing the channel, slot or hollow cross-section could be introduced by the most varied of deposition processes. In the case of silicon, this takes place advantageously by thermal oxidation since, during oxidation of a silicon atom into the silicon dioxide molecule, its volume increases by a factor 2.25 and hence the clear opening cross-section can be reduced or be closed completely. Hence the production of optical waveguides and other structures in the depth of the silicon structure is generally also possible.

FIG. 11a to 11e show such a possibility, starting from the state achieved in FIG. 9d. After removing the SiO₂ layer (FIG. 11b), a layer 59 is applied which also partially fills the hollows or channels 52. Subsequent thereto, the substrate 41 is removed at least partially from its rear side by etching (FIG. 11d) and, in the last step, the part of the layer 59, which is situated on the base of the hollow or of the channel 48, is then opened from the rear side by etching (FIG. 11e), as a result of which a pipe connection-like extension 60 with an extremely small diameter remains on the underside of the remaining structure.

The invention is not restricted to the described embodiments which can be modified in many ways. According to an embodiment of the invention, another arbitrary layer, e.g. a semiconductor layer, metal layer (in particular aluminium), dielectric layer or superconductive layer, furthermore a conductive or non-conductive polymer layer or a layer system comprising a combination of these layers, can be applied on the layers 7, 42 with the opening structure.

Furthermore, the invention relates with particular advantage also to a use of an opening, which is characterised in that the layer material is integrated with the opening, in particular in the front part of a bending beam, in particular a so-called cantilever, which is fixed on one side (e.g. U.S. Pat. No. 5,116,462 A, U.S. Pat. No. 5,399,232 A). An advantageous embodiment of the use thereby resides in the fact that a single bending beam or a plurality of bending beams is inserted in a matrix arrangement, in particular in scanning probe microscopy, as sensor elements. It has thereby proved to be advantageous that, by deposition of a thin layer which is not particularly transparent optically, the bending beam or beams can be used for simultaneous scanning force microscopy (AFM, SFM) and scanning near-field optical microscopy (SNOM), the opening being able to be used as a miniaturised source (illumination mode) during illumination of the opening from the surface of the layer or the light power is picked up by an illuminated probe through the opening itself (collection mode). By sequential deposition of materials, such as e.g. metals, semiconductors, organic materials or the like, on the front and/or rear side of the substrate, a miniaturised contact point can be obtained furthermore at the position of the aperture.

A further advantageous embodiment resides in the fact that a matrix-shaped arrangement of one or more openings on planar substrates or on structured surfaces (e.g. cantilevers) is used for dosing and/or injection of exact, very small quantities of liquid or gas. An example of such a structure is illustrated in FIG. 12. Analogously for example to the state achieved in FIG. 7c, firstly a structure 61 with a tip portion 31, which has an opening 33, is produced here, said tip portion being disposed at one end of a bending beam 62 which can be fixed in a mounting or the like at the other end corresponding to the normal cantilever construction (FIG. 12a). By means of at least partial etching of the substrate 1 from the rear side, the thickness of the bending beam can be reduced to the desired extent and the tip portion 31 can be exposed analogously to FIG. 11e.

The embodiment according to FIG. 11 makes possible a multiplicity of further applications. If the hollows or channels 48, 52 according to FIG. 9 or 11, which are produced by etching, extend completely or partially through the substrate 41 and are filled subsequently with a transparent and/or dielectric material, such as e.g. SiO₂, a polymer or the like, optical waveguide structures, which can be used analogously to optical fibre cables, are obtained, said waveguide structures making it possible to connect optical and optoelectronic component parts in the dimension perpendicular to the substrate.

Analogously thereto, the channels can also be filled with conductive materials (metals, conductive polymers, semiconducting materials etc.) to produce thus through-contactings (via throughs). If these are filled only partially, then hollow waveguides are produced which are of interest for electrical and optical applications. Finally, also a combination of these materials is conceivable. If the hollows or channels are coated with conductive material and then with a dielectric material and if thereafter the exposed volumina are filled with conductive material, then a coaxial line which is well known in electrotechnology is obtained, said coaxial line being of interest in particular for high frequency applications. Hence, the invention makes possible in particular also the production of component parts which are suitable for electronic and/or optical transmission of signals.

Furthermore, the method according to the invention can be applied, instead of to recesses which terminate in an ideal tip, also to recesses which have a V-shaped channel with a plateau-shaped base or are configured in the manner of an inverse pyramid stump, in that for example the etching process implemented for producing the structures is interrupted before reaching the actual tip. The expression “tapering”, which is used above and in the claims, is intended to include plateau shapes of this type. Furthermore, it is possible to provide the substrate or, after removal thereof, the remaining thin layer 7, 42 on the upper side and/or the underside with a metal layer. As a result, the possibility exists of specifically reducing the size of the already present openings. At the same time, the metal layer also ensures improvement in the optical properties of a sensor provided with such an opening for a near-field microscope. When removing the substrate 1, 41 from the rear side of the layers 7, 42 with known methods, tip structures with extremely small openings at their apex can be obtained in very thin layers 7, 42. If larger openings are desired, then the obtained openings can be specifically enlarged either before or after the removal of the substrate by a further etching process. Miniaturised openings of a defined size can thus be produced on the entire substrate by this method. Furthermore, the channel-like or pyramid-like structures can also be produced by methods other than those described, e.g. by means of chemical or electrochemical etching processes, ion beam etching processes or also by mechanical indentation. In addition, instead of KOH, also e.g. NaOH, LiOH or the like or organic solutions could be applied. Finally, it is understood that the different features can be applied also in combinations other than those illustrated and described.

1. Method for producing at least one small opening (10, 33, 47) in a layer on a substrate (1, 41), in particular a semiconductor substrate, the substrate (1, 41) being provided on the upper side (2) with at least one tapering recess (6), which has a tip portion (4) and side walls (5), the upper side (2) of the substrate (1, 41) being covered at least in the region of the recess (6) with a layer (7, 42) made of an etchable material and the opening (10, 33, 47) being then produced in the region of the tip portion (4) of the recess (6) by etching of the layer (7, 42), characterised in that the opening (10, 33, 47) is produced from the upper side (2) by selective opening of the layer (7, 42) by means of an anisotropic plasma etching method which is matched to the material of the layer (7, 42), the material, the etching gases and the etching parameters being chosen such that, in the region of a tip portion (9, 31) of the layer (7, 42) of the recess (6, 30), which tip portion (9, 31) lies in the tip portion (4) of the substrate (1, 41), a greater etching rate is produced than in the region of side walls (8, 32) of the layer (7, 42) which lie on the side walls (5) of the substrate (1, 41).

2. Method according to claim 1, characterised in that silicon is used as substrate (1, 41) and silicon dioxide as the material of the layer (7, 42).

3. Method according to claim 2, characterised in that a silicon substrate (1, 41) with a (001) face is used as upper side.

4. Method according to claim 1, characterised in that the plasma etching method is implemented using argon and trifluoromethane.

5. Method according to claim 1, characterised in that germanium, gallium arsenide or indium phosphide is used as substrate.

6. Method according to claim 1, characterised in that the substrate (1, 41), subsequent to the production of the opening (10, 33, 47), is subjected to a deep etching step using the layer (7, 42) as etching mask.

7. Method according to claim 6, characterised in that the substrate (41) is provided with a through-opening (52) by means of deep etching.

8. Method according to claim 1, characterised in that the substrate (41) is provided on the upper side with a plurality of channel-like and/or pyramid-like recesses (43, 44, 45) and with a layer (42) which covers these, and in that a corresponding plurality of openings (47) is configured in the layer (42).

9. Method according to claim 8, characterised in that the substrate is provided with a corresponding plurality of through-openings (52), using a deep etching step and the layer (42) as mask.

10. Method according to claim 1, characterised in that a plane-parallel disc is used as substrate (1, 41).

11. Method according to claim 1, characterised in that at least one opening is applied at least on one edge, in a subsequent method step a further layer with preselected properties.

12. Method according to claim 1, characterised in that at least one opening is configured in a free portion of a bending beam which is fixed on one side.

13. Calibration standard for scanning probe microscopy, characterised in that it comprises a plane-parallel substrate (41) with a plurality of through-openings (52) which are produced with the method according to claim 1.

14. Micromechanical sensor with a bending beam (62), which is fixed on one side and is provided at one free end with a tip, characterised in that the tip (31) has an opening (33) which is produced according to the method according to claim 1.

15. Component part for electrical/optical transmission of electrical/optical signals, characterised in that it is produced according to the method according to claim 9, the openings (52) being filled with a conductive or dielectric material.
